(19) United States
(12) Patent Application Publication
(10) Pub. No.: US 2004/0153344 A1
(43) Pub. Date: Aug. 5, 2004

(54) System and method for creating and updating a mobile patient care plan in real-time

(76) Inventors: Tuan Bui, Green Oaks, IL (US); E. Jane Wilson, Libertyville, IL (US); Tom Dudar, Palatine, IL (US); Peter Tomicki, Janesville, WI (US); Randolph Meinzer, Spring Grove, IL (US); Martin Monaghan, Evanston, IL (US); Kurt Attermeier, Spring Grove, IL (US); Janet Mullan, Antioch, IL (US); James Martucci, Libertyville, IL (US)

Correspondence Address: FRANCIS C. KOWALIK, ESQ., CORPORATE COUNSEL, LAW DEPARTMENT, BAXTER INTERNATIONAL INC., ONE BAXTER PARKWAY, DF2-2E, DEERFIELD, IL, 60015, US

(21) Appl. No.: 10/414,456

(22) Filed: Apr. 15, 2003

(51) Int. Cl. G06F 17/60

(52) U.S. Cl. 705/3; 705/2

(57) ABSTRACT

A system and method for creating and updating a mobile medical record are provided. The system and method include a radio frequency identification tag storing medical record data such as patient data. A handheld computing device downloads a medical care plan from a record database via a communication network. The handheld computing device is equipped with a radio frequency identification interrogator that is capable of reading data from and writing data to the radio frequency identification tag. Thus, the handheld computing device is capable of creating and updating a medical record stored on the radio frequency identification tag.

### CROSS-REFERENCE TO RELATED APPLICATIONS

Not Applicable.

### FEDERALLY SPONSORED RESEARCH OR DEVELOPMENT

Not Applicable.

### BACKGROUND OF THE INVENTION

The present invention relates to systems and methods for creating and monitoring health care plans, and more particularly, the present invention relates to a system and method that allows for real-time creating and monitoring of mobile patient care plans using radio frequency identification (RFID) technology.

Historically, medical or patient records were maintained for a number of reasons including documentation and billing purposes as well as facilitating communication between various physicians. Further, the data collected in patient records was used in a variety of ways including, for example, medical research. These reasons are still important, but over time, patient records have become increasingly important for other reasons such as evaluating the effectiveness of a treatment plan. Further, compiling patient records can decrease medical errors and ensure compliance with treatment regimens. Thus, medical and patient records allow medical providers to provide, among other things, quality assurance.

Conventionally, medical and patient records were collected using papers files and/or logbooks. With advances in technology, computerized record keeping has become more prevalent. However, many computerized record keeping systems still require a care provider to record activities in a written logbook so that the data can be entered into the computerized system at a later time. Data entry of information recorded in the logbook can result in errors, and further, there is no way to ensure that the entries in the logbook are made in a timely and efficient manner.

Additionally, for many health care providers, the cost of implementing computerized record keeping systems can be prohibitive. Further, many computerized record keeping systems are not mobile and do not allow for real-time updating of patient and/or medical information.

Accordingly, a need remains for a system and method that reduces errors in record keeping by providing an accurate record of all patient and/or medical related activities. Further a need exists for a system and method that are mobile in application and that allow for real-time updating of patient and/or medical information.

### SUMMARY OF THE INVENTION

An advantage of the present invention is, therefore, to provide a radio frequency identification tag adapted to be worn by a patient and configured to store and transmit medical data. The medical data includes data relating to the patient. Preferably, the medical data is encoded. In an embodiment, the radio frequency identification tag is an active tag. In an alternative embodiment, the radio frequency identification tag is a passive tag.

In an embodiment of the present invention, a mobile medical record system is provided. The mobile medical record system includes a radio frequency identification tag adapted to be worn by a patient and a handheld computing device having a radio frequency identification reader. The handheld computing device is configured to read and write information to the radio frequency identification tag via the radio frequency identification reader.

The mobile medical record system in an embodiment further includes at least one medical database storing medical information, a communication network, and a communication device in communication with the handheld computing device. Preferably, the communication device is configured to communicate the medical information from the medical database to the handheld computing device via the communication network. In an embodiment, the communication device is further configured to communicate information from the handheld computing device to the medical database via the communication network. Preferably, the medical information includes information relating to the patient. Preferably, the medical information is encoded.

The handheld computing device in one embodiment is a personal digital assistant and the communication device is a docking station for the personal digital assistant. In an alternative embodiment, the communication device may be an optical communication device, a Bluetooth communication device, a radio frequency communication device, a microwave communication device, or the like. The radio frequency identification tag in one embodiment is an active tag. In an alternative embodiment, the radio frequency identification tag is a passive tag.

In an embodiment according to the present invention, a mobile medical record system is provided. The system includes a radio frequency identification tag adapted to be worn by a patient, a handheld computing device having a radio frequency identification reader and at least one medical database. The handheld computing device is configured to read and write information to the radio frequency identification tag via the radio frequency identification reader. The medical database stores medical information. The system may further include a communication network and a communication device in communication with the handheld computing device. The communication device is configured to receive the medical information from the medical database via the communication network and to transmit information to the medical database via the communication network.

A mobile medical record system is provided in one embodiment according to the present invention. The system includes at least one medical database storing medical information, a communication network, a radio frequency identification tag adapted to be worn by a patient, and a handheld computing device having a radio frequency identification reader. The handheld computing device is configured to communicate with the radio frequency identification tag via the radio frequency identification reader. The radio frequency identification reader is configured to allow the handheld computing device to communicate with the medical database via the communication network.

In addition, the present invention provides an embodiment of a patient monitoring system. The system includes a radio frequency identification tag adapted to be worn by a patient and at least one radio frequency identification reader. The radio frequency identification reader is adapted to read and write information to the radio frequency identification tag when the tag comes within a predetermined range of the reader.

The patient monitoring system in one embodiment further includes at least one concerned party and a communication network, whereby the radio frequency identification reader is programmed to communicate information to the concerned party via the communication network when a triggering event occurs. The concerned party in an embodiment is one of a family member of the patient, an emergency response team, a police department, a fire department, a medical provider, a medical facility or the like.

The patient monitoring system may further include an event database connected to the communication network, whereby the radio frequency identification reader is programmed to communicate information to the event database via the communication network. The event database preferably stores event information transmitted from the radio frequency identification reader and compares the stored information to incoming information to predict the occurrence of an event.

The present invention is also directed to methods of generating a radio frequency identification tag, keeping an electronic record, and tracking a movement of a patient using the features described above.

Additional features and advantages of the present invention are described in, and will be apparent from, the following Detailed Description of the Invention and the Figures.

### BRIEF DESCRIPTION OF THE FIGURES

FIG. 1 is a schematic view disclosing functional relationships between components of one embodiment of the present invention.

FIG. 2 is a schematic view disclosing functional relationships between components of one embodiment of the present invention.

FIG. 3 is a schematic view disclosing functional relationships between components of one embodiment of the present invention.

FIG. 4 is a flow chart showing a method of generating a RFID tag according to an embodiment of the present invention.

FIG. 5 is a flow chart showing a method for recording medical activities according to an embodiment of the present invention.

FIG. 6 is schematic diagram illustrating a patient monitoring embodiment according to the present invention.

### DETAILED DESCRIPTION OF THE INVENTION

While this invention is susceptible of embodiment in many different forms, there is shown in the drawing, and will be described herein in detail, specific embodiments thereof with the understanding that the present disclosure is to be considered as an exemplification of the principles of the invention and is not intended to limit the invention to the specific embodiments illustrated.

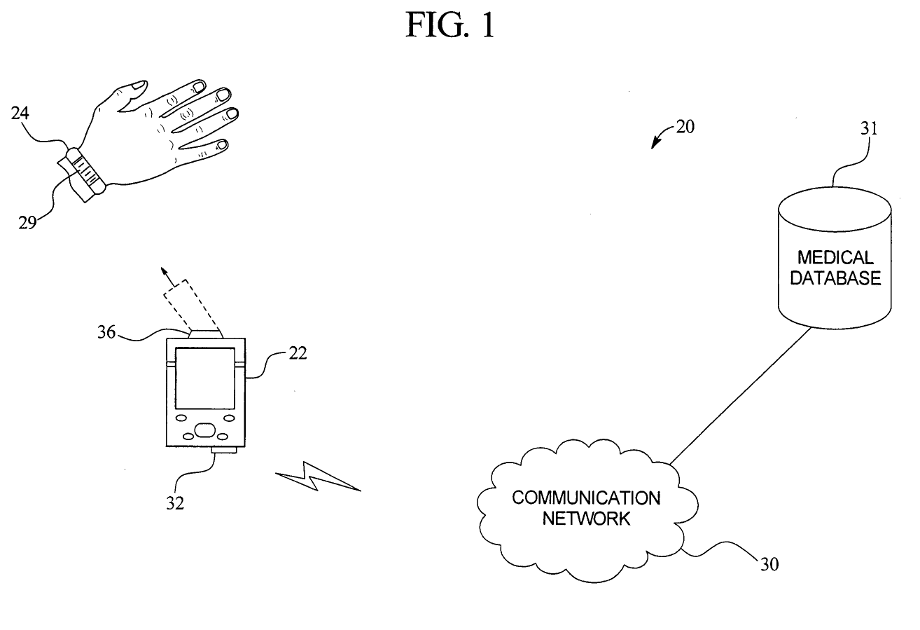

Referring to the drawings, FIG. 1 shows a schematic view disclosing functional relationships between components of one embodiment of the present invention. A mobile medical record system is generally disclosed and referred to with the reference numeral 20. The mobile medical record system 20 generally includes a label or a tag 29 to be adapted to be worn by a patient, a handheld computing device 22, a communication network 30, and at least one medical database 31.

In an embodiment, the tag 29 is a radio frequency identification (RFID) tag or label. The RFID tag 29 is capable of storing information provided in a machine readable format using RFID technology. In an embodiment, the information stored in the RFID tag 29 includes a mobile patient care plan. Preferably, the RFID tag 29 is attached to a tag holder 24 which is adapted to be worn by a patient. In an embodiment, the tag holder 24 is in the form of a patient identification bracelet.

The RFID tag 29 is preferably generated by a hospital administrator based upon information in the medical database 31. In an embodiment, the medical database 31 is a hospital administration database. Patient data stored in the RFID tag 29 may include but is not limited to patient name, patient identification number, and patient drug allergies or other allergies. Further information including text information may also be included in the RFID label 29, such as patient name, patient identification number, medical record number, patient type, date of birth, age, gender, date of admission, and allergies.

The handheld computing device 22 in one embodiment is capable of reading information from and writing information to the RFID tag 29 through a first transceiver 36. Preferably, the first transceiver 36 is a RFID reader or interrogator such as the Hand'IT™ contactless reader by Inside Technologies. Generally, a RFID reader or interrogator includes electronics that have RFID read and write functionality. In an embodiment, the first transceiver 36 is an expansion module that interfaces with the handheld computing device 22 via an expansion port or slot (not shown). Alternatively, the first transceiver 36 may be equipped during the manufacturing process of the handheld computing device 22.

As discussed above, medical record information including patient data according to an embodiment of the present invention is provided in machine readable formats using RFID technology. RFID technology includes “smart tags” or “smart labels” such as Omron's V720 Series inlets and tags or Tag-it™ products from Texas Instrument Radio Frequency Identification Systems. RFID tags provide a large amount of data in a condensed space.

Further, RFID tags have very high readability since they do not have to be oriented with respect to a reader to be scanned. As described below, information contained on an RFID tag or label can be erased, appended or rewritten.

RFID tags also offer increased flexibility, privacy and security since the data can be encoded and/or encrypted. Encoded and/or encrypted information can only be accessed with the proper encoding/encryption and decoding/decryption techniques and/or equipment. Further, various encoding and/or encryption techniques allow for the optimization of stored and transferred information. It should be appreciated that any suitable form of data encryption or encoding may be used in accordance with the present invention.

Generally, RFID tags include a transponder that allows for communication with the RFID tag. RFID tags employ transponders having various read and write functionality. For example, a transponder may be read only (R/O), read/write (R/W) or write once/read many (WORM). Further, transponders used on RFID tags have varying power sources. For instance, an active transponder is equipped with battery power, thereby providing greater reading distances while a passive transponder is powered by the RF energy emitted from a reader or interrogator, thereby providing for lower costs.

Transponders may operate at different frequency ranges. For example, a low frequency transponder may operate at about 125 kHz with a read range of about 10 cm while a high frequency transponder operates at about 13.56 MHz with a read range of about 1 m to about 5 m. Further, a transponder may even operate at an ultra high frequency within the range of 433-915 MHz and 2.45 GHz with a read range from about 3 m to about 20 m under FCC regulations.

The RFID tag or label 29 is preferably generated by a software interface application. However, it should be appreciated that the RFID tag 29 may be generated by any suitable hardware or software interface and/or application. For example, the RFID tag may be generated by a software interface application that utilizes the print data stream from a pharmacy information system (PIS) and incorporates the appropriate data fields into the RFID tag 29. A key benefit of this configuration is the ability to generate RFID tags integrated with text without the support of the pharmacy system vendor.

In an embodiment, as described above, the handheld computing device 22 is equipped with at least one transceiver, the first transceiver 36 for reading and writing information such as patient data from the RFID tag 29. Again, in an embodiment, the first transceiver 36 is an RFID reader or interrogator. Further, the handheld computing device 22 is preferably equipped with a storage device (not shown) for storing information. The storage device of the handheld device 22 may include various types of memories such as a hard drive, a floppy disk, a compact disc, an optical medium, magnetic storage, and the like. Also, as shown in FIG. 1, the handheld computing device 22 may be configured to communicate with other electronic devices via a second transceiver 32.

The transmission and downloading of information from the handheld computing device 22 to the medical database 31 via the communication network 30 in one embodiment is by way of the second transceiver 32. In an embodiment, the transmission and/or reception of information is accomplished using infrared technology in which the second transceiver 32 is an infrared transceiver and the communication network 30 is equipped with a corresponding infrared transceiver. Alternate methods of communication include wireless communication such as IEEE 802.11, BLUETOOTH® communication, radio frequency communication, optical communication, and the like. It should be appreciated that the communication network can be any suitable network including, for example, a medical or hospital intranet or the Internet.

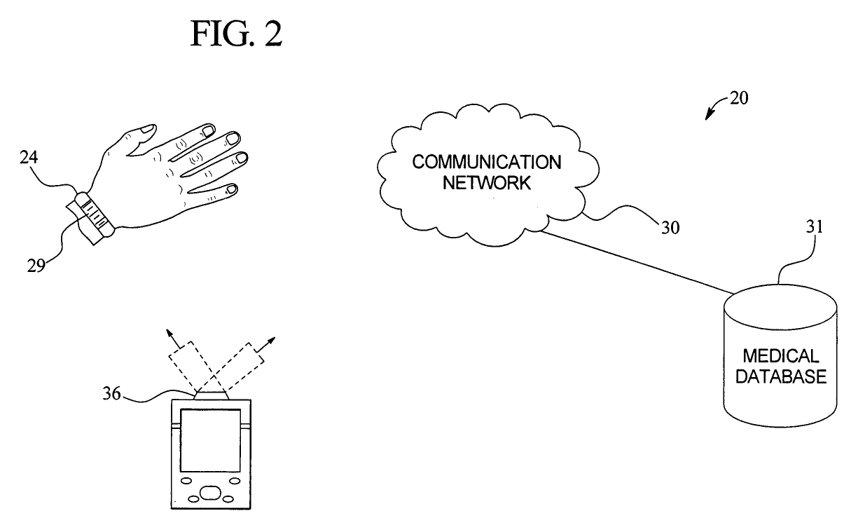

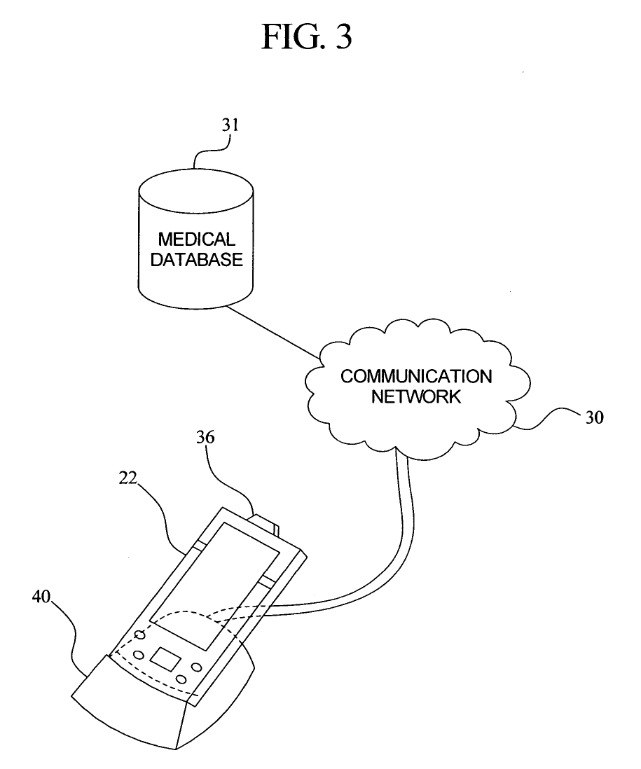

With reference to FIG. 2, an embodiment is shown where the handheld computing device 22 communicates with the medical database 31 over the communication network 30 via the first transceiver 36 which, as described above, is a RFID interrogator. Thus, the handheld computing device 22 is capable of communicating with both the RFID tag 29 and the medical database 31 using only the first transceiver 36. In a further embodiment shown in FIG. 3, the handheld computing device 22 is configured to communicate with the medical database 31 over the communication network 30 via a docking station or module 40. In an embodiment, the docking module 40 interfaces with a personal computer (not shown) that is connected to the communication network 30.

Suitable handheld computing devices include but are not limited to laptop, tablet, palmtop or handheld computers such as a personal digital assistant (PDA). Examples of a PDA include a Palm Handheld, various handheld devices from Handspring, and Pocket PC models from Compaq and Hewlett-Packard. It should be appreciated that any suitable brand of PDA or portable computer is capable of being used. A PDA is advantageous in that it can be easily and inexpensively configured to meet the needs of the present invention. An additional advantage is that a PDA can be upgraded to provide, among other things, additional software applications and hardware devices.

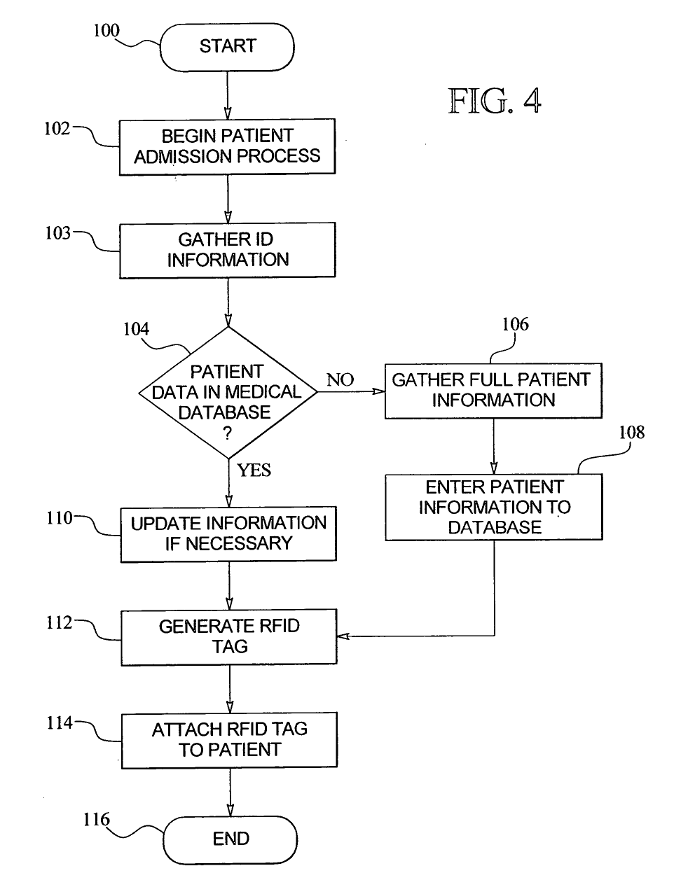

Referring now to FIG. 4, a method for generating a RFID tag is described. The RFID tag used in this embodiment is a R/W passive transponder. However, it should be appreciated that this method is equally applicable to a RFID tag having any suitable transponder. The method starts at start block 100 and continues to block 102 where a patient admission process begins. The patient admission process can be, for example, admitting a patient to a hospital, a clinic, or the like. As part of the admission process, identification information is gathered from the patient as indicated by block 103. This identification information can include information such as the patient's name and/or social security number.

Subsequent to gathering the identification information from the patient, a check is made to see whether the patient's full information has been previously entered into a medical database as indicated by decision diamond 104. In an embodiment, the medical database is a hospital administration database. If the patient's full information has not previously been entered into the medical database, then the patient's full information will need to be gathered from the patient as indicated by block 106. After gathering the patient's full information, the full information should be entered into the medical database as indicated by block 108. However, it should be appreciated that in alternative embodiments, the steps indicated by blocks 106 and 108 could be combined into one step. For example, the patient's full information could be simultaneously entered into the database as it is being gathered from the patient. Further, the system could provide a way for patients to enter their own full information, for example, via the Internet.

If it is determined at decision diamond 104 that the patient's full information is already in the database, then the patient's information is updated, if necessary, as indicated by block 110. For example, if the patient has moved, the patient's address would be updated in the medical database. Once the patient's full information has been entered into the medical database as indicated by block 108, or once the patient's information has been updated as indicated by block 110, a RFID tag can be generated as indicated by block 112.

The RFID tag can store any of the information contained in the medical database relating to the patient. For example, the RFID tag could store identification information relating to the patient, such as the patient's age, name, date of birth, gender, hair color, eye color, height, weight, photo identification of the patient, and the like. Further, the RFFD tag can be programmed to store data relating to tests previously performed on the patient, a patient's allergies, special instructions relating the patient such as a vegetarian meal preference, and the like. It should be appreciated that the information stored on the RFID tag can be specific to the medical facility, specific to the nature of the medical treatment to be performed on the patient, or customized to meet any variable that might be encountered during the treatment and record keeping process. Thus, a patient in a hospital for heart surgery might have extensive information programmed to the RFID tag while a patient in a clinic for a routine physical might have minimal information programmed to the RFID tag.

Once the RFID tag has been generated with the desired information stored thereon, the RFID tag is attached to the patient as indicated by block 114. For example, the RFID tag could be attached to a standard patient identification bracelet that is worn by the patient. Thus, the RFID tag serves as a mobile medical record for the patient. Accordingly, the process of generating the RFID tag ends as indicated at termination block 116.

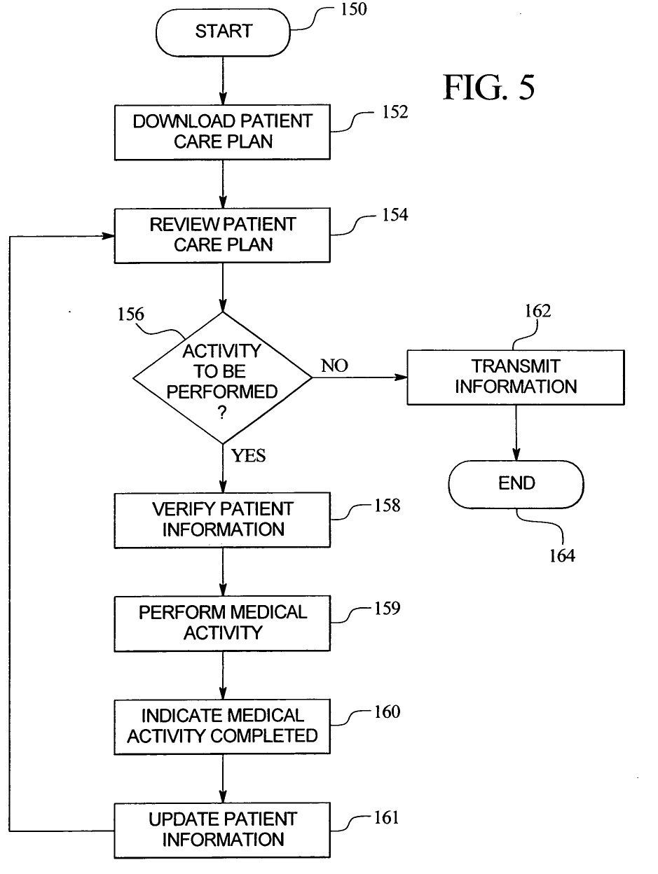

Referring now to FIG. 5, a method for recording medical activities using an RFID tag is described. In general, a software application contained on a handheld computing device guides the user such as a care provider or nurse clinician through the process of gathering medical information from a medical database and updating the medical information as medical activities are performed. The method starts at start block 150 and continues to block 152 where a patient care plan is downloaded to the handheld computing device from a medical database. After downloading the patient care plan, the care provider reviews the patient care plan as indicated by block 154. By reviewing the patient care plan, the care provider is able to determine whether a medical activity needs to be performed as indicated at decision diamond 156.

If an activity needs to be performed, the care provider must verify the patient information as indicated by block 158 before proceeding. The care provider verifies the patient information by reading the patient's RFID tag with the handheld computing device. In an embodiment, the software application provides an alert signal to show that the patient information matches the patient information relating to the medical activity to be performed according to the patient care plan. The alert signal may be an audible signal, a visual signal or a combination of an audible or a visual signal. Further, the alert signal could include another sensory stimulation such as a vibration.

Further, it should be appreciated that in an embodiment, the handheld computing device also displays the patient's identification information on the display screen of the handheld computing device. Since the patient's identification information includes distinguishing features such as hair color, eye color, height, weight, complexion, distinguishing marks, and the like, the care provider is able to perform a secondary check to ensure that the proper patient is treated. Further, it should be appreciated that the photo identification of the patient is displayed on the handheld computing device in an alternative embodiment.

Once the care provider has verified the patient information, the care provider performs the medical activity as indicated by block 159. For example, the medical activity might be delivering a dose of an oral medication to the patient at a predetermined time. Thus, the care provider would deliver the proper dose of medication to the patient at the proper time as indicated by block 159. It should be appreciated that the medical activity could be any suitable medical activity including drawing a blood sample, performing kidney dialysis, measuring body temperature, and the like.

After performing the medical activity, the care provider indicates that the medical activity is completed as indicated by block 160. For example, the care provider presses a “complete” button on the handheld computing device. Pressing the “complete” button signals that the medical activity is completed and the handheld computing device updates the patient's medical record as indicated by block 161 by writing information to the RFID tag. If the medical activity was delivering an oral dose of medication as described above, the handheld computing device will write to the patient's RFID tag that the medication was taken along with the name of the medication. It should be appreciated that the handheld computing device can write other information to the RFID tag including, for example, the time the medication was taken and the name of the care provider who delivered the medication. Thus, the handheld computing device writes information to the RFID tag detailing the medical activity performed by the care provider on the patient, thereby creating in real-time, a mobile medical record including patient information. In addition, the care giver could also be equipped with an RFID tag or badge similar in nature to the patient RFID tag for identifying the care giver and for maintaining a record of the care giver's activities.

After updating the patient information, the care provider reviews the plan as described above and as indicated at block 154. If no further activity needs to be performed as indicated by decision diamond 156, then the care provider is ready to transmit information as indicated by block 162. This step of transmitting information includes transmitting information from the handheld computing device to the medical database and from the handheld computing device to the RFID tag, if necessary. After all of the information has been updated and transmitted, the method ends as indicated by termination block 164.

The method described above uses only one patient plan and one patient, but it should be appreciated that a number of patient plans could be downloaded to the handheld computing device and the care provider could administer to each of the respective patients. Thus, for example, a nurse could be assigned a certain number of patients corresponding to a specified area of the hospital and the patient care plans for each of these patients would be downloaded to the nurse's handheld computing device. In this manner, a number of nurses would each carry a load of patients and their respective patient care plans would be downloaded to each of the nurse's handheld computing devices. Supervisor's and doctors would also be able to download patient care plans and their patients would overlap with the nurses, thereby creating a comprehensive medical record keeping system.

Further, it should be appreciated that responsibility for the patient will inevitably be transferred from one nurse and/or doctor to a different nurse and/or doctor. Thus, the system of the present invention adapts to this need by providing a mechanism allowing patient care plans to be transferred among the respective handheld computing devices. Transfer can be accomplished in any suitable manner including via the communication network 30 or directly from one handheld computing device to another handheld computing device, for example, via an infrared communication device.

The system described above, including the handheld computing device 22 can be programmed to include Neofax information, drug facts and comparisons, American Society of Health-System Pharmacists, and other features such as a dose calculator.

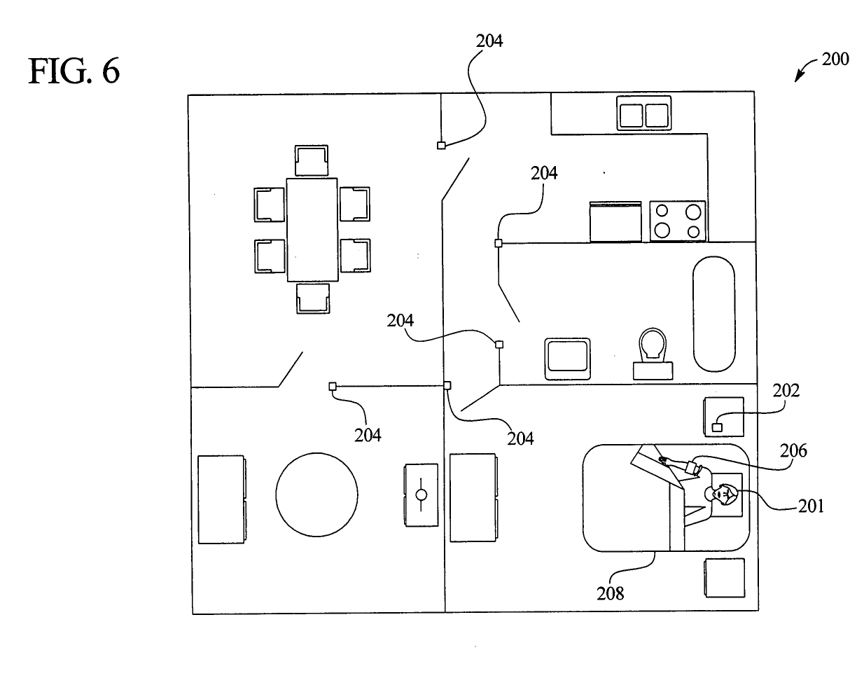

FIG. 6 illustrates an embodiment of a patient monitoring system 200 according to the present invention. The patient monitoring system is designed to track and/or analyze a patient's movement, that is, to perform asset management and/or portal management. In the embodiment illustrated in FIG. 5, the patient's motion is tracked in a homecare environment in which the patient resides alone. However, it should be appreciated that a patient's movement can be tracked in any suitable environment including, for example, a hospital room and/or facility.

As part of the patient monitoring system, the patient 201 wears a RFID tag 206. The tag can be worn by the patient in any suitable manner, but attaching the RFID tag to a standard identification bracelet or anklet is preferred. In this respect, the bracelet or anklet should be designed such that removal of the bracelet or anklet is not an easy task. Thus, the RFID tag is more likely to be with the patient and the tracking information is more likely to be accurate. Preferably, the RFID tag includes information identifying the patient.

To accomplish the tracking, at least one radio frequency reader 202 is strategically placed in the patient's house. In this embodiment, a number of additional radio frequency identification readers 204 are strategically placed in each doorway of the patient's house. Thus, each of the radio frequency readers is able to communicate with the RFID tag 206 when the patient 201 passes through or nears the corresponding doorway and/or reader.

In this embodiment, the radio frequency identification reader 202 is a home base reader 202 and is placed near a home base which in this embodiment is the patient's bed 208. Thus, the home base reader 202 is able to communicate with the RFID tag 206 when the patient returns to bed or home base 208. As the patient 201 travels throughout the house, the RFID tag 206 comes into communication with at least one of the readers 202 and 204. In an embodiment, the readers 202 and 204 write the patient's position to the RFID tag 206 including a time stamp. Thus, as the patient travels throughout the house, a record is kept on the RFID tag of the patient's movement.

In an alternative embodiment, the readers 202 and 204 do not write any information to the RFID tag 206, but they do record tracking information to an external source (not shown). The external source could be a standalone personal computer or a personal computer in communication with a concerned party such as a family member of the patient, an emergency response team, a fire department, a police department, a medical facility, the like and combinations thereof. In an embodiment, the readers 202 and 204 directly communicate the tracking information to the concerned party without the use of personal computer via a communication device (not shown). The communication device could be, for example, a modem connected to a phone line, a digital network connection such as a DSL connection or a satellite connection, the like and combinations thereof.

The readers 202 and 204 in one embodiment are capable of being monitored and programmed via the communication device. Thus, the concerned party could program the readers 202 and 204 from an external location. Alternatively, the concerned party could merely monitor readers 202 and 204 from an external source to, for example, compile a statistical report based on the patient's movement over a specified period of time.

The readers 202 and 204 may be equipped to notify the concerned party if a predetermined event occurs. The predetermined event could be, for example, a lack of movement by the patient over a predetermined period of time, for example, one hour. Further, the event could be the patient not returning to home base within a predetermined period of time. Thus, the readers 202 and 204 are designed to notify the concerned or interested party that something may be wrong, thereby giving the interested party advance warning in case medical assistance is needed.

It should be appreciated that the predetermined period of time for the triggering event can be adjusted depending on a number of factors including, for example, the patient's medical history and/or condition. Further, the predetermined period of time can be programmed to change with the time of day. For example, during late evening hours, the predetermined period of time might be extended because a patient would most likely be sleeping and not be moving around as much as during the daytime hours. Along the same line, if movement does occur during the evening hours, this movement in itself might be a triggering event because it could signal that something awakened the patient from sleep. Either way, it should be appreciated that suitable variables will cause the programming of the monitoring system to be changed to create a comprehensive tracking profile that is designed to anticipate changes based on recorded information and environmental factors.

Further, it should be appreciated that adaptive or predictive algorithms may be employed to anticipate and/or predict the occurrence of an event. Thus, a patient monitoring system according to an embodiment of the present invention could be configured to adapt and learn through, for example, artificial intelligence. The system can learn, for example, by creating a database of events and analyzing the response of the system leading up to each of the events. Thus, the system would be able to build a pattern for each of the events and would be able to predict the occurrence of an event. The system would continue to build the database of events over time and the ability of the system to predict and/or anticipate the occurrence of a specified event will thus also increase over time. Further, it should be appreciated that the above-described event database could be separate from, integrated with, or in communication with the above-described medical database.

The system may also provide the ability for a user to customize the variables based on an expected pattern of behavior. User customizable variables can work independent of the artificial intelligence algorithms or they can be configured to work cooperatively with the artificial intelligence algorithms. In one embodiment, the system analyzes patient behavior patterns contained, for example, in the event database and creates a profile of patient movement based on the analysis.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A radio frequency identification tag adapted to be worn by a patient and configured to store and transmit medical data.

2. The radio frequency identification tag of claim 1, wherein the medical data includes data relating to the patient.

3. The radio frequency identification tag of claim 1, wherein the medical data is at least one of encoded and encrypted.

4. The radio frequency identification tag of claim 1, wherein the radio frequency identification tag includes an active tag.

5. The radio frequency identification tag of claim 1, wherein the radio frequency identification tag includes a passive tag.

6. The radio frequency identification tag of claim 1, wherein at least a portion of the medical data is generated by a software interface application that utilizes the print data stream from a pharmacy information system.

7. A mobile medical record system, comprising:
a radio frequency identification tag adapted to be worn by a patient; and
a handheld computing device having a radio frequency identification reader, the handheld computing device configured to read and write information to the radio frequency identification tag via the radio frequency identification reader.

8. The mobile medical record system of claim 7, further comprising:
at least one medical database, the medical database storing medical information;
a communication network; and
a communication device in communication with the handheld computing device, the communication device configured to communicate the medical information from the medical database to the handheld computing device via the communication network.

9. The mobile record system of claim 8, wherein the communication device is further configured to communicate information from the handheld computing device to the medical database via the communication network.

10. The mobile record system of claim 8, wherein the medical information includes information relating to the patient.

11. The mobile record system of claim 8, wherein the handheld computing device is a personal digital assistant and the communication device is a docking station for the personal digital assistant.

12. The mobile record system of claim 8, wherein the communication device is selected from the group consisting of an optical communication device, a radio frequency communication device, and a microwave communication device.

13. The mobile record system of claim 8, wherein the medical information is at least one of encoded and encrypted.

14. The mobile record system of claim 8, wherein the radio frequency identification tag is an active tag.

15. The mobile record system of claim 8, wherein the radio frequency identification tag is a passive tag.

16. The mobile record system of claim 8, wherein at least a portion of the information stored on the radio frequency identification tag is generated by a software interface application that utilizes the print data stream from a pharmacy information system.

17. A mobile medical record system, comprising:
a radio frequency identification tag adapted to be worn by a patient;
a handheld computing device having a radio frequency identification reader, the handheld computing device configured to read and write information to the radio frequency identification tag via the radio frequency identification reader;
at least one medical database, the medical database storing medical information;
a communication network; and
a communication device in communication with the handheld computing device, the communication device configured to receive the medical information from the medical database via the communication network and to transmit information to the medical database via the communication network.

18. A mobile medical record system, comprising:
at least one medical database, the medical database storing medical information;
a communication network;
a radio frequency identification tag adapted to be worn by a patient; and
a handheld computing device having a radio frequency identification reader, the handheld computing device configured to communicate with the radio frequency identification tag via the radio frequency identification reader, the radio frequency identification reader further configured to allow the handheld computing device to communicate with the medical database via the communication network.

19. A patient monitoring system, comprising:
a radio frequency identification tag adapted to be worn by a patient; and
at least one radio frequency identification reader, the radio frequency identification reader adapted to read and write information to the radio frequency identification tag when the tag comes within a predetermined range of the reader.

20. The patient monitoring system of claim 19, the system further comprising:
at least one concerned party; and
a communication network, the radio frequency identification reader being programmed to communicate information to the concerned party via the communication network when a triggering event occurs.

21. The patient monitoring system of claim 20, wherein the concerned party is selected from the group consisting of a family member of the patient, an emergency response team, a police department, a fire department, a medical provider, and a medical facility.

22. The patient monitoring system of claim 20, further comprising an event database connected to the communication network, the radio frequency identification reader being programmed to communicate information to the event database via the communication network.

23. The patient monitoring system of claim 22, wherein information contained in the event database is used to analyze patient behavior patterns and to create a profile of patient movement.

24. The patient monitoring system of claim 20, wherein the radio frequency identification reader can be at least one of programmed and monitored via the communication network.

25. A method of generating a radio frequency identification tag, the method comprising the steps of:
gathering identification infonnation from a patient;
locating the patient's medical record in a medical database using the identification information; and
generating a radio frequency identification tag, the tag storing at least a portion of the patient's medical record.

26. The mobile record system of claim 25, wherein the radio frequency identification tag is generated by a software interface application that utilizes the print data stream from a pharmacy information system.

27. A method of keeping an electronic record of a medical activity performed on a patient, the method comprising the steps of:
downloading a patient care plan from a medical database via a communication network;
reviewing the patient care plan to determine a medical activity to perform on the patient;
verifying patient information by reading a radio frequency identification tag adapted to be worn by the patient;
performing the medical activity;
indicating that the medical activity has been completed; and
updating the patient information by writing to the radio frequency identification tag;

28. The method of keeping an electronic record of a medical activity performed on a patient as claimed in claim 27, the method further comprising the step of transmitting information relating to the completed medical activity to the medical database via the communication network.

29. A method of tracking a movement of a patient within a desired environment, the method comprising the steps of:
placing at least one radio frequency identification reader in a strategic location within the desired environment, the reader designed to read a radio frequency identification tag adapted to be worn by the patient;
reading the tag when the tag comes within a predetermined area surrounding the reader; and
writing information to the tag each time the tag comes within the predetermined area surrounding the reader.

30. The method of tracking a movement of a patient within a desired environment as claimed in claim 29, wherein the information written to the tag includes time information and location information.

31. The method of tracking a movement of a patient within a desired environment as claimed in claim 29, wherein the reader is configured to communicate with a concerned party via a communication network.

32. The method of tracking a movement of a patient within a desired environment as claimed in claim 31, wherein the concerned party is selected from the group consisting of a family member of the patient, an emergency response team, a police department, a fire department, a medical provider, and a medical facility.

33. The method of tracking a movement of a patient within a desired environment as claimed in claim 31, the method further comprising the step of contacting the concerned party when a predetermined event occurs.

34. The method of tracking a movement of a patient within a desired environment as claimed in claim 29, further comprising the step of supplying the information written to the tag to an external source.

35. The method of tracking a movement of a patient within a desired environment as claimed in claim 34, wherein the external source is an event database.

36. The method of tracking a movement of a patient within a desired environment as claimed in claim 35, further comprising the steps of:
comparing the information written to the event database to information previously written to the event database; and
predicting an occurrence of an event based on the comparison.

37. The method of tracking a movement of a patient within a desired environment as claimed in claim 35, further comprising the steps of:
accessing the event database to analyze patient behavior patterns; and
creating a profile of patient movement based on the analysis.

38. The method of tracking a movement of a patient within a desired environment as claimed in claim 31, wherein the reader is configured to be at least one of monitored and programmed via the communication network.
